(19) United States
(12) Patent Application Publication
(10) Pub. No.: US 2007/0130045 A1
(43) Pub. Date: Jun. 7, 2007

(54) Method and apparatus for tracking the progress of an auction

(75) Inventor: John Matthew Farson, Charlotte, NC (US)

Correspondence Address: NELSON MULLINS RILEY & SCARBOROUGH, LLP, 1320 MAIN STREET, 17TH FLOOR, COLUMBIA, SC, 29201, US

(73) Assignee: Auction Answers, LLC

(21) Appl. No.: 11/295,197

(22) Filed: Dec. 6, 2005

(51) Int. Cl. G06Q 40/00

(52) U.S. Cl. 705/37

(57) ABSTRACT

The invention is a method for broadcasting the progress of an auction. The method includes designating an identifier for each potential bidder and electronically displaying a representation of the items being auctioned in a location that is accessible to the bidders. The method further includes electronically marking the items being displayed with the identifier of the bidder in a winning position and electronically providing real-time updates by changing the identifiers as a bidder places a higher bid that creates a new winning scenario.

### BACKGROUND OF THE INVENTION

The invention relates to the field of auctions. More specifically, the invention relates to the field of combinatorial auctions.

Auctions are known in the art as an efficient way to sell property, goods, and services. Three common types of auctions are forward auctions, reverse auctions, and sealed bid auctions. In recent years, combinatorial auctions have become a popular method of selling more than one unit of goods, real estate, services, natural resources, and the like, as well as combinations thereof.

In a combinatorial auction, a bid may be placed for a single unit, or a bid may be placed for a bundle of units. An auctioneer holding properties wishes to maximize the value obtained through the auction of the properties. Bidders may have a willingness to exchange more value for combinations of properties than they would for individual elements of the combination, if considered alone and aggregated. For example, if A, B, C, D, and E were adjacent parcels of land along the bank of a river, and a bidder had a willingness to pay P1 for parcel A alone, P2 for parcel B alone, and P3 for parcel C alone, the bidder may have a greater willingness to pay more for the combination of the three adjacent parcels than P1+P2+P3. The bidder may also be willing to pay more for the assurance that all parcels will be won.

To the auctioneer, it is then desirable to structure an auction to allow a bidder to bid in combinations to gain the value of their synergies. Similarly, it is desirable for bidders to be able to bid on combinations. Otherwise, bidders may risk overbidding in an eventually unsuccessful attempt to obtain a combination of properties when a combinatorial auction format is unavailable. Additionally, because an auction may have many units (i.e., in excess of 100) resulting in millions of potential combinations and potential winning scenarios, bidders often suffer from confusion regarding the current winning scenarios.

Winner determination in combinatorial auctions means choosing which bids to accept so as to maximize the sum of the prices of the accepted bids. Computer programs capable of determining winners of combinatorial auctions are known in the art.

Combinatorial auctions are often conducted in large rooms, (e.g., hotel meeting rooms), where the progress of the auction can be difficult to follow. The auctioneer enters new bids into a computer, often located at the front of a room, and the resulting winning scenario from the new bids are calculated by the combinatorial auction program. The new winning scenario must then be communicated to the bidders to allow additional bids to be placed as desired. Present combinatorial auction programs and methods do not provide an efficient way of communicating or displaying the progress of the auction as the auction is being conducted.

The step of communicating the new leading bids in the new winning scenario to a large number of people in a hotel room or at remote locations may be, and often is, cumbersome. This is especially true when a large number of items, such as plots of land, are being auctioned. Additionally, where a large number of items are being auctioned, there are many possible combinations of those items. For example, the auction may be for land and for natural resources associated with the land, for example timber separately, with more than 100 plots of land available. In such a situation, bids could be made for combinations of land, combinations of timber, and combinations of land and timber. A new winning bid scenario may result in numerous changes, including new combinations, new price-per-acre figures, new single tract bids, new acreage figures in winning combinations, and new winning bidders.

Current methods of communicating changes in winning scenarios include writing the new scenarios on white boards at the front of the room in which the auction is being conducted. This method is inefficient due to the time it takes to manually change the relevant information. This inefficiency may result in a slower auction scenario, with bidders having to wait for updates before placing new bids, and increased confusion among the bidders.

Additionally, this inefficiency may lead to apathy among bidders due to the length of the auction. As apathy increases, bidders become less interested and are less likely to continue participating in the auction.

For example, a winning scenario in a combinatorial auction for thirty eight lots of land, depicted in Table 1, may replace a simple scenario such as that depicted in Table 2. The time required to make such drastic changes may lead to delays in the auction as discussed above. Even if the changes are minor, the overall results and combinations may be complex and difficult to follow.

As discussed above, previous methods of broadcasting changes in a winning scenario require the auctioneer, or an assistant, to monitor the changes as they occur and update the winning scenario by hand. Those having ordinary skill in the art recognize that this often time-consuming process slows down an auction, leading apathy, confusion, and mistakes.

Additionally, tables, such as the one below, are often difficult to follow, even when only a few changes are made. Those having ordinary skill in the art will recognize that the progress of an auction would be difficult to follow when the changes occur quickly, are not readily apparent between different scenarios, and/or are slowly updated.

Inefficiency in broadcasting changes in the auction's progress may also lead to erroneous, unnecessary, and time-consuming calculations by bidders determining their next bids. These erroneous calculations may result in additional lost time and productivity as well as bidder confusion, thereby resulting in more inefficiency in the process.

TABLE 1
Representative Winning Scenario ($2,574,000)

| | | | | Price |
|---|---|---|---|---|
| Lots | Amount of Bid | Bidder Number | Acres | Per Acre |
| 1-4 | 140,000 | 77 | 200.220 | 699 |
| 5 | 89,000 | 78 | 70.530 | 1,262 |
| 6 | 42,000 | 105 | 52.100 | 806 |
| 7 | 94,000 | 110 | 136.110 | 576 |
| 8 | 45,000 | 5 | 69.610 | 645 |
| 9, 12 | 100,000 | 1 | 132.840 | 753 |
| 10 | 25,000 | 100 | 17.660 | 1,416 |
| 11 | 23,000 | 39 | 25.910 | 888 |
| 13 | 25,000 | 75 | 39.520 | 633 |
| 14 | 70,000 | 29 | 86.430 | 810 |
| 15, 16, 24, 25 | 800,000 | 70 | 603.440 | 1,326 |
| 17, 18 | 75,000 | 78 | 97.850 | 766 |
| 19 | 30,000 | 75 | 43.020 | 697 |
| 20, 34, 35 | 360,000 | 1 | 378.840 | 950 |
| 21 | 35,000 | 4 | 47.350 | 739 |
| 22 | 26,000 | 49 | 38.520 | 675 |
| 23 | 29,000 | 74 | 46.820 | 619 |
| 26 | 28,000 | 5 | 25.610 | 1,093 |
| 27 | 32,000 | 134 | 45.810 | 699 |
| 28 | 28,000 | 104 | 25.410 | 1,102 |
| 29, 30, 31, 32 | 290,000 | 102 | 185.280 | 1,565 |
| 33 | 68,000 | 126 | 77.100 | 882 |
| 36 | 38,000 | 50 | 81.570 | 466 |
| 37, 38 | 82,000 | 103 | 82.660 | 992 |

TABLE 2
Representative Second Place Scenario ($2,460,000)

| Lots | Amount of Bid | Bidder Number | Acres | Price Per Acre |
|---|---|---|---|---|
| 1-14, 16-38 | 1,830,000 | 51 | 2206 | 829 |
| 15 | 630,000 | 124 | 431 | 1,462 |

### SUMMARY OF THE INVENTION

In one aspect the invention is a method for broadcasting the progress of an auction. The method includes designating an identifier for each potential bidder and electronically displaying a representation of the items being auctioned in a location that is accessible to the bidders. The method further includes electronically marking the items being displayed with the identifier of the bidder in a winning position and electronically providing real-time updates by changing the identifiers as a new bidder places a higher winning bid.

In another aspect, the invention is an apparatus for broadcasting the progress of an auction. The apparatus includes a processor for electronically generating information regarding the progress of the auction and a screen for broadcasting the electronically generated information. The information can include at least a list of the items being auctioned and identifiers representing bidders in a winning position.

In yet another aspect, the invention is a method for broadcasting the progress of a land auction. The method includes designating an identifier for each potential bidder, electronically displaying, in a location that is accessible to the bidders, a first map of the land being auctioned, and identifying, on the first map, the various plots of land that are being auctioned. The method further includes marking the map with the identifiers of the bidders in a winning position, marking the map with the identifiers of the bidders in a second place position, and electronically providing real-time updates by changing the identifiers as a new bidder places a higher winning bid.

The foregoing, as well as other objectives and advantages of the invention and the manner in which the same are accomplished, is further discussed within the following detailed description and its accompanying drawings.

### BRIEF DESCRIPTION OF THE DRAWING

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements.

FIG. 1 is a representative depiction of a display of a winning scenario in accordance with the present invention.

FIG. 2 is a representative depiction of a display of a second place scenario in accordance with the present invention.

### DETAILED DESCRIPTION

The invention relates to broadcasting the progress of an auction. The invention allows potential bidders in an auction to easily follow the progress of an auction, for example a land auction. As used herein, the term “potential bidder” refers to all bidders, including those that have not yet placed a bid and those that have already placed a bid, but may place another one.

In an exemplary embodiment, the present invention provides real-time updates of a winning scenario in an auction, such as a combinatorial auction, to allow the potential bidders to track their bids and determine whether new bids are needed. The invention is especially useful for bidders who are placing combination bids (e.g., a single bid for more than one item in the auction) or competing against combination bids. Additionally, the real-time updates facilitate the auction by preventing apathy among the bidders due to the delays inherent in the traditional methods of broadcasting the progress of combinatorial auctions.

The present invention is not limited to land auctions, but may be utilized in auctions of any of the types of property (real or personal) and/or services capable of being offered for sale in an auction format. Non-limiting examples include auctions for real estate, personal property, services, natural resources, such as timber, water rights, mining rights, and the like, as well as combinations thereof. For example, auctions offering land and timber or other natural resources separately are contemplated. The invention is especially useful in scenarios where combination bids may be desirable. Because the items may be bid upon concurrently, rather than sequentially as in the traditional auction scenario, the invention enables potential bidders to follow the progress of multiple items. The invention further facilitates concurrent bidding and combinatorial bidding by alleviating the uncertainty relating to the progress of traditional combinatorial auctions.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

For ease of discussion, the method and apparatus will be described with reference to combinatorial auctions. Those having ordinary skill in the art will recognize that the invention is applicable to auctions having formats other than the format of combinatorial auctions, and shall not be so limited. Similarly, the method will be described with respect to land auctions for ease of discussion. Those having ordinary skill in the art will recognize that the invention is applicable to auctions of other items, such as personal property and natural resources, and shall not be so limited.

In one aspect, the invention is a method for broadcasting the progress of an auction. The method can include designating an identifier for each potential bidder. Exemplary identifiers include one or more of colors, patterns, numbers, letters, codes, and other identifiers known in the art as well as combinations thereof (such as combinations of letters and numbers or colors and patterns). Stated differently, suitable identifiers are those capable of graphically or visually distinguishing bidders associated with a particular identifiers from one another when electronically displayed as described herein.

The step of designating an identifier may include allowing each bidder to choose an identifier or may include assigning an identifier to each bidder. Additionally, the step of designating an identifier can include both allowing the bidders to choose identifiers and assigning identifiers to the bidders.

In some embodiments, some of the graphical identifiers may change with each winning scenario. For example, an identifier, such as a bidder number, will remain the same throughout the auction, but colors or patterns will change as new winning scenarios are created. Stated differently, the colors or patterns are not assigned to a particular bidder in this scenario. Rather, the colors or patterns are selected by the processor in the manner that best displays the winning scenario and the colors and patterns are reassigned to bidders throughout the bidding process as the winning scenario and winning combinations change in response to the placement of new bids. Accordingly, in this embodiment, one bidder identifier remains constant throughout the auction and one or more other identifiers change throughout the auction.

The method further includes electronically displaying a representation of the items being auctioned in a location that is accessible to the bidders, either as a group, as individuals, or both. Exemplary locations may include at the front of a room in which the auction is being conducted, over an intranet system, over the internet, or combinations thereof. Other locations are also contemplated, such as along the sides of a room and other locations known in the art.

Exemplary methods of electronically displaying the representation of the items being auctioned may include one or more of electronically projecting the representation onto a screen, such as a projector screen (at the front or along the sides of a room) of sufficient size to allow larger groups to view the information at substantially the same time; transmitting the representation over the internet or an intranet; or displaying the representation on an electronic screen, such as a computer monitor. The method may include electronically displaying the information on more than one screen (i.e., on more than one type of screen or on more than one of the same type of screen, or both).

The method may also include electronically displaying the information in more than one location. In some embodiments, the information may be displayed in one or more locations other than the location in which the auction is being conducted, or in addition to the location in which the auction is being conducted. For example, the information may be displayed in one or more of a different room, a different location in the same building as the primary display, or in a different building, as well as combinations of these or other suitable locations.

The method may further include displaying a map depicting land being auctioned. The map may be schematic, topographic, photographic, and combinations thereof.

In an exemplary embodiment, the representation of the items being auctioned is electronically marked with the identifier of a bidder or bidders in a winning position. As used herein, the term “winning position” or “winning scenario” means the current leading combination of bids. The display of the bidders in a winning position may be updated automatically or manually when a new bid, resulting in a new winning position, is entered. The step of manually updating the information may include instructing a computer system to update the display after a new bid has been placed. In another embodiment, the step of automatically updating the information may involve programming that does not require an additional command from a user before updating the displayed information. Accordingly, in one embodiment, the displayed information is automatically updated in real-time when a new bid results in a new winning scenario.

In an exemplary embodiment, the identifiers of bidders in a winning position are electronically updated in a real-time manner when a new bid is made. The ability to update the display in a real-time manner enables improved monitoring of the auction by interested bidders. Additionally, real-time updates increase the speed of the auction, thereby improving bidder interest and minimizing the apathy brought about by longer auctions. Moreover, presenting a winning scenario in a graphical format as recited herein may further alleviate confusion among potential bidders, as the potential bidders may be able to more quickly understand a graphical representation than a numerical representation. Additionally, the ability to provide real-time updates in the current winning scenario may also reduce confusion among the potential bidders.

In one embodiment, the method further includes electronically marking the items being electronically displayed with the identifier of the bidder or bidders in a second place position. The identifiers of the bidders in a second place position may be displayed by alternating the displayed information between a winning scenario and a second place scenario. In another embodiment, the second place scenario and the winning scenario may be concurrently displayed on different maps or on the same map.

In another embodiment, the method may include the step of electronically displaying additional information such as the price per acre represented by the winning scenario. The step may also include displaying the price per acre represented by the second place scenario. Additionally, the number of units (i.e., acres or goods) represented by each leading bidder in a current winning scenario may be electronically displayed.

In another aspect, the present invention is a system for broadcasting the progress of an auction. The apparatus includes a processor for electronically generating information regarding the progress of an auction and a screen for broadcasting the electronically generated information. In an exemplary embodiment, the information regarding the progress of the auction includes at least the items being auctioned and identifiers representing bidders in a winning position.

In one embodiment, the screen is positioned away from the processor (i.e., in another part of a room, in another room, in another building, etc.). In another embodiment, the screen is positioned adjacent the processor. In a typical embodiment, the screen is positioned against a wall in a position that is viewable throughout the room or location in which the auction is being conducted. In another embodiment, the screen is positioned at a location remote from the processor, for example in another building or town.

In one embodiment, the apparatus includes more than one screen. In another embodiment, the screen is large enough to be viewed from various positions within a room. In exemplary embodiments, the size of the screen may vary depending on the size of the location in which the screen is being utilized.

Exemplary screens contemplated as useful in the present invention include one or more of screens for receiving an electronically transmitted signal from the processor, whether the signal is over a wired or a wireless connection, and screens for receiving an electronically projected image. As will be recognized by those having ordinary skill in the art, such screens are commercially available.

In some embodiments, the processor may electronically transmit a signal to a second processor, such as over the internet. The second processor may then electronically transmit a signal to the screen.

The apparatus may further include a projector in electronic communication with said processor for projecting an electronically transmitted image onto the screen.

The apparatus may also include a computer program for conducting a combinatorial auction. Those having ordinary skill in the art will recognize that combinatorial auction programs are known in the art. The present apparatus may utilize known combinatorial auction programs for calculating the bids in a winning position and in a second place position as is known in the art. The results of the calculations are then efficiently and conveniently displayed in accordance with the present method of broadcasting the progress of the auction.

The displayed information may include a representation of the items being auctioned. In exemplary embodiments, where the items being auctioned are plots of land, the displayed information may include a map. As previously discussed, the map may be schematically represented, topographically represented, or photographically represented. In an exemplary embodiment, a schematic map is superimposed, or positioned, on a photograph of the land being auctioned.

The representation of the items being auctioned may be marked with the identifiers of the bidder or bidders in winning positions. Exemplary identifiers are discussed above. The representation of the items being auctioned may also be marked with the identifiers of the bidder or bidders in a second place position. As will be recognized by those having ordinary skill in the art, the winning scenario and the second place scenario of a combinatorial auction may include some identical information, where one bidder is in an individual winning position in both the overall winning scenario and second place scenario.

The information displayed may also include additional information, such as current price per acre, time remaining in an auction (when the auction is a timed auction), and other information relevant to the progress of the auction. Those having ordinary skill in the art will recognize the other information that is relevant to the progress of an auction and will recognize that the identity of relevant information may be dependent on the items being auctioned. The invention is intended to include such relevant information.

Additionally, the display may include more than one representation of the items being auctioned to provide concurrent information regarding the winning scenario and the second place scenario. The information regarding the current winning scenario and the current second place scenario may also be displayed in an alternating manner. In another embodiment, the information being displayed may also include additional scenarios, such as the third or fourth place scenario.

In another aspect, the invention is a method of broadcasting the progress of a land auction including designating an identifier for each potential bidder, electronically displaying in a location that is accessible to the bidders, a first map of the land being auctioned. The method further includes identifying, on the first map, the various plots of land that are being auctioned. The method also includes marking, preferably electronically, the map with the identifiers of the bidders in a winning position, marking the map with the identifiers of the bidders in an a second place position, and electronically providing real-time updates by changing the identifiers to represent a new winning scenario as a bidder creates a higher winning bid.

The method may further include the steps of electronically displaying at least a second map and marking the second map with the identifiers of the bidders in a second place position.

In one embodiment, the method further includes electronically displaying a photograph of the land being auctioned with the first map superimposed over the photograph. The second map may be superimposed over a second photograph of the land being auctioned.

In another embodiment, the method may further include the option of auctioning natural resources, such as water rights, mining rights, and timber on the land separately from the land itself. In this embodiment, one bidder may be in a winning position with respect to the land while another bidder may be in a winning position with respect to the timber. Accordingly, the method may include displaying information relating to a winning scenario wherein one bidder is in a winning position with respect to the land and timber and a second place scenario in which one bidder is in a second place position with respect to a plot of land and a different bidder is in a second place position with respect to the timber on the land.

### EXAMPLES

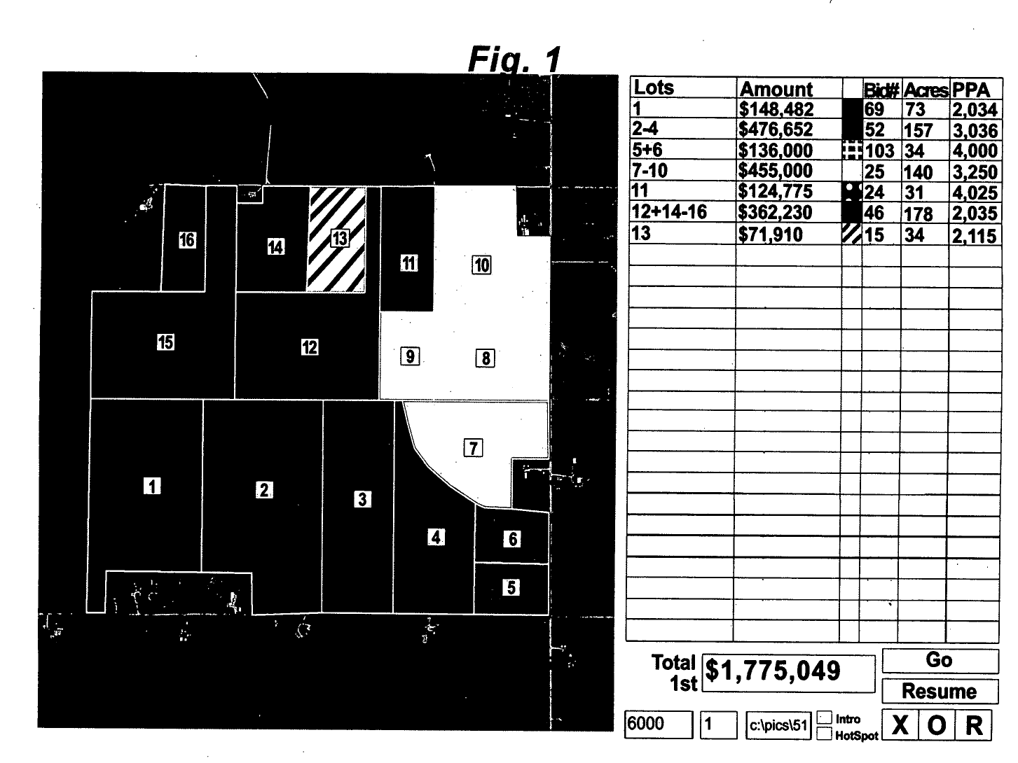

FIG. 1 is a representative depiction of displayed information relating to a winning scenario in accordance with the present invention. Those having ordinary skill in the art will recognize that the figure is representative only and does not limit the information that may be displayed in accordance with the present invention.

As depicted in FIG. 1, a map of lots of land 1-16 being auctioned is displayed. The map includes an aerial photograph of the surrounding land with a tract map of the land being auctioned superimposed over the photograph. The tract map is divided into sixteen plots of land 1-16. A chart to the right of the map depicts the current winning scenario, with columns showing the current winning bid for each lot, or combination of lots; the current winning bidders (by both pattern and number); the current price per acre, and the total acres controlled by each winning bidder. As can be seen in the figure, the current winning bidders are each assigned a number and a pattern. The tract map includes the pattern of the current winning bidder for each plot of land.

In the depicted winning scenario of FIG. 1, bidder number 69 has placed a bid for lot number 1 and is in a current winning position with a bid of $148,482. Bidder number 52 has placed a bid in the amount of $476,652 for the combination of lots 2, 3, and 4. Bidder number 103 has placed a bid of $136,000, placing that bidder in a winning position with respect to lots 5 and 6. Bidder number 25 has placed a bid in the amount of $455,000 for lots 7, 8, 9, and 10. Bidder number 24 is in a winning position for lot 11 with a current winning bid of $124,775. Bidder number 46 has placed a bid of $362,230 for lots 12, 14, 15, and 16 and bidder number 15 is in a current winning position for lot number 13 with a leading bid of $71,910. The figure also depicts the current total of the winning scenario, $1,775,049.

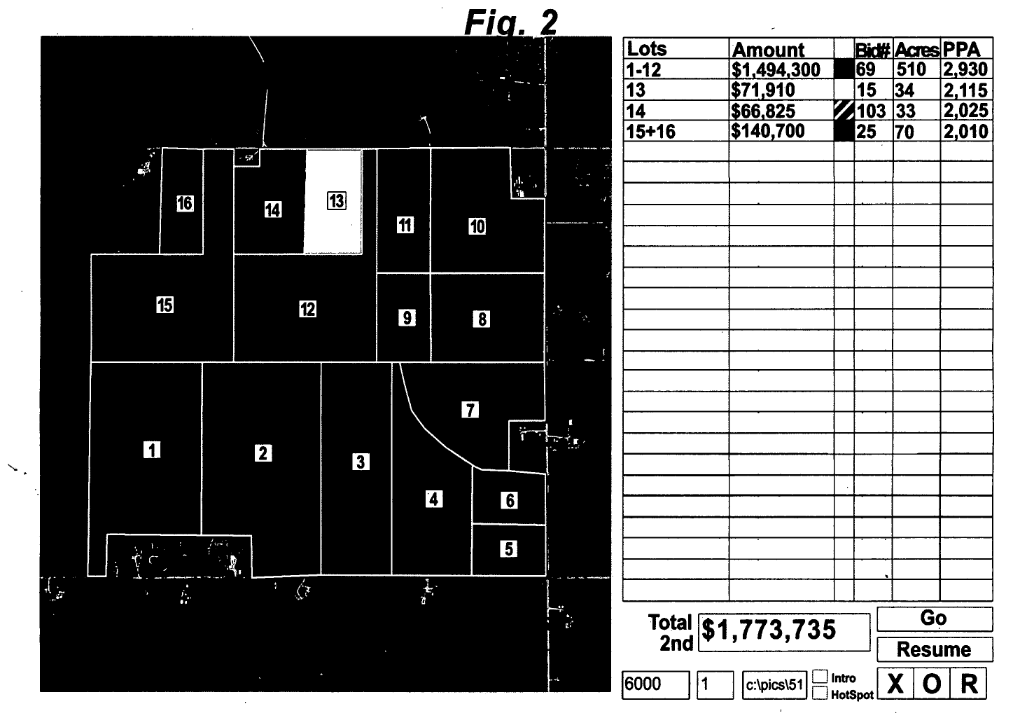

FIG. 2 is a representative depiction of displayed information relating to a second place scenario, which was replaced by the current winning scenario in FIG. 1, in accordance with the present invention. Those having ordinary skill in the art will recognize that the figure is representative only and does not limit the information that may be displayed in accordance with the present invention.

In the depicted second place scenario of FIG. 2, the total value of all bids is $1,773,735. Bidder number 69 controlled lots 1-12 with a bid of 1,494,300, bidder number 103 controlled lot 14 with a bid of $66,825, and bidder number 25 controlled lots 15 and 16 with a bid of $140,700. Bidder number 15 controlled lot 13 with a winning bid of $71,910. As can be seen by comparing FIGS. 1 and 2, bidder number 15 controls lot 13 in both the winning scenario and the second place scenario at the same price. Bidder number 15 maintained this position because no other bidder placed a subsequent bid that disturbed the control of lot 15.

The Figures also demonstrate an embodiment of the present invention wherein the bidder numbers are constant throughout the auction, but the pattern assigned to a particular bidder can, but not necessarily will, change with each subsequent winning scenario.

In the specification, drawings, and examples, there have been disclosed typical embodiments of the invention and, although specific terms have been employed, they have been used in a generic and descriptive sense only and not for purposes of limitation, the scope of the invention being set forth in the following claims.

1. A method for broadcasting the progress of an auction comprising:
designating an identifier for each potential bidder;
electronically displaying a representation of the items being auctioned in a location that is accessible to the bidders;
electronically marking the items being displayed with the identifier of a bidder in a winning position; and
electronically changing the identifiers as a bidder places a higher bid to reflect a new winning position.

2. A method according to claim 1 wherein the step of designating an identifier for each bidder comprises designating a color for each bidder.

3. A method according to claim 1 wherein the step of designating an identifier for each bidder comprises designating a pattern for each bidder.

4. A method according to claim 1 wherein the step of designating an identifier for each bidder comprises designating a number for each bidder.

5. A method according to claim 1 wherein the step of designating an identifier for each bidder comprises designating a letter for each bidder.

6. A method according to claim 1 wherein the step of designating an identifier for each bidder comprises designating a code for each bidder.

7. A method according to claim 1 wherein the step of designating an identifier for each bidder comprises allowing the bidder to choose an identifier.

8. A method according to claim 1 wherein the step of designating an identifier for each bidder comprises assigning an identifier to the bidder.

9. A method according to claim 1 wherein the step of electronically displaying a representation of the items being auctioned comprises displaying the representation by electronically projecting the representation onto a screen.

10. A method according to claim 1 wherein the step of electronically displaying a representation of the items being auctioned comprises displaying the representation over the internet.

11. A method according to claim 1 wherein the step of electronically displaying a representation of the items being auctioned comprises displaying the representation on an electronic screen.

12. A method according to claim 1 wherein the step of electronically displaying a representation of the items being auctioned comprises displaying a map representing plots of land.

13. A method according to claim 1 wherein the step of electronically displaying a representation of the items being auctioned comprises electronically displaying the information on more than one screen.

14. A method according to claim 1 wherein the step of electronically displaying a representation of the items being auctioned comprises displaying the information in more than one location within one room.

15. A method according to claim 1 further comprising the step of marking the items being displayed with the identifier of the bidder in a second place position.

16. A method according to claim 15 wherein the step of marking the items with the identifier of the bidder in a winning position and the step of marking the items with the identifier of the bidder in the second place position are conducted concurrently.

17. A method according to claim 15 wherein the step of marking the items with the identifier of the bidder in a winning position and the step of marking the items with the identifier of the bidder in the second place position are repeated more than one time each and are alternated.

18. A method according to claim 1 wherein the step of electronically displaying a representation of the items being auctioned comprises displaying price per unit information.

19. A method according to claim 1 wherein the step of electronically displaying a representation of the items being auctioned comprises displaying the number of units in the new winning scenario.

20. A method according to claim 1 wherein the step of electronically providing real-time updates by changing the identifiers as a bidder places a higher bid comprises automatically updating the identifiers in response to the higher bid.

21. A method according to claim 1 wherein the step of electronically providing real-time updates by changing the identifiers as a new bidder places a higher bid comprises manually updating the identifiers in response to the higher bid.

22. A system for broadcasting the progress of an auction comprising:
a processor for electronically generating information regarding the progress of the auction;
a screen for broadcasting the electronically generated information; and
wherein the information regarding the progress of the auction includes at least a list of the items being auctioned and identifiers representing bidders in a winning position.

23. A system according to claim 22 wherein said screen is a screen for receiving an electronically transmitted signal from said processor.

24. A system according to claim 22 wherein said screen is a screen for receiving an electronically projected image.

25. A system according to claim 24 further comprising a projector in electronic communication with said processor.

26. A system according to claim 22 wherein said screen is a computer screen at a remote location.

27. A system according to claim 22 wherein said information further includes identifiers representing bidders in a second place position.

28. A system according to claim 22 wherein said list of items being auctioned is schematically represented as a map of land plots being auctioned.

29. A system according to claim 28 wherein said map is superimposed over a photograph of the land plots being auctioned.

30. A system according to claim 28 wherein said map is schematic.

31. A system according to claim 28 wherein said map is topographic.

32. A system according to claim 28 wherein said land plots are marked with the identifier of the bidder in a winning position.

33. A system according to claim 22 wherein said information further includes price per acre information.

34. A system according to claim 22 wherein said information further includes time remaining in the auction.

35. A system according to claim 22 further comprising at least one additional screen for broadcasting the progress of the auction.

36. A system according to claim 22 wherein said screen is in a position remote from said processor.

37. A method of broadcasting the progress of a land auction comprising:
designating an identifier for each potential bidder;
electronically displaying, in a location that is accessible to the bidders, a first map of the land being auctioned;
identifying, on the first map, the various plots of land that are being auctioned;
marking the map with the identifiers of the bidders in a winning position;
marking the map with the identifiers of the bidders in a second place position; and
electronically providing real-time updates by changing the identifiers as a new bidder places a higher bid.

38. The method of claim 37 wherein the step of electronically displaying a map comprises electronically displaying a photograph of the land being auctioned with a map superimposed on the photograph.

39. The method of claim 37 wherein the step of marking the map with the identifiers of the bidders in a winning position and the step of marking the map with the identifiers of the bidders in a second place position are conducted in a repeating, alternating fashion.

40. The method of claim 37 further comprising the step of electronically displaying at least a second map of the land being auctioned and marking the first map with the identifiers of the bidders in a winning position while marking the second map with the identifiers of the bidders in a second place position.

41. The method of claim 37 further comprising the step of electronically displaying the price per acre represented by a winning bid.

42. A method according to claim 37 wherein the step of electronically displaying a representation of the items being auctioned comprises displaying the number of acres in the new winning scenario.
